(19) United States
(12) Patent Application Publication
(10) Pub. No.: US 2004/0207120 A1
(43) Pub. Date: Oct. 21, 2004

(54) Method and apparatus for removing modular forms

(75) Inventor: Eugene Gargiulo, Durham, CT (US)

Correspondence Address: MCCORMICK, PAULDING & HUBER LLP, CITY PLACE II, 185 ASYLUM STREET, HARTFORD, CT, 06103, US

(73) Assignee: Form Puller Tool Co., Inc., Centerbrook, CT

(21) Appl. No.: 10/839,673

(22) Filed: May 5, 2004

Related U.S. Application Data
(63) Continuation-in-part of application No. 10/012,624, filed on Dec. 7, 2001.

(51) Int. Cl. B28B 13/06

(52) U.S. Cl. 264/334; 249/66.1

(57) ABSTRACT

A method and tool for removing modular forms from underlying rigid concrete are disclosed. The tool includes a lever end, a fulcrum, and a claw end having a notch particularly adapted to engage a knob that protrudes from a surface of the modular form. The method includes engaging the claw end of the tool with the knob, abutting the fulcrum against rigid concrete adjacent the modular form, and exerting a force on the lever end in the direction of the adjacent rigid concrete. Alternatively, the tool can include a head having a projection to engage a slot defined in a modular form.

### CROSS-REFERENCE TO RELATED APPLICATION

This is a continuation-in-part application of application Ser. No. 10/012,624, filed on Dec. 7, 2001, the disclosure of which is herein incorporated by reference in its entirety.

### FIELD OF THE INVENTION

This invention relates generally to methods and tools for building construction. It relates more particularly to a method and tool for removing modular forms from underlying rigid concrete.

### BACKGROUND

Certain building sections such as foundations for buildings or bridges are typically constructed with concrete for its advantages of high compressive strength, resistance to degradation by ground and water contact, and lower total cost as compared to stacked masonry units. These concrete building sections are usually framed by forms that create a mold into which fluid concrete is poured and cured. Forms may be of any rigid material that will withstand the pressures of poured concrete. Historically, forms were typically made from plywood with a thickness of at least one-inch, custom cut for a particular job site. These plywood forms were then strengthened with various vertical and horizontal bracing as appropriate for the project at hand.

Recent changes in the industry have led to the use of pre-fabricated modular forms or panels in standard sizes, where the modular forms are intended to be reused over numerous and varied projects. Modular forms of the type described herein are known in the art. These modular forms fit together easily and reduce the need for customized forms, thereby reducing the labor involved in arranging them to receive poured concrete. Modular forms typically include knobs that protrude from the side opposite that confining the concrete. These knobs allow bracing to be readily secured to bind adjacent forms to each other and to strengthen them against separation or rupture from the weight of concrete poured behind them.

After the concrete is cured sufficiently, usually a few days, the forms are removed. Whether custom made or prefabricated modular forms, the surface of the forms against which concrete comes in contact are pre-treated with a release agent, typically a diesel fuel based fluid, to facilitate removal without destroying the forms. Workers generally force pry bars, wedges and the like between the form and the hardened concrete to break the bond between them. Some workers use a hooked end of the pry bar to ‘ratchet’ the edge of a modular form away from the concrete structure. Using the pry bar in this way tends to deform the edge or a surface of the modular form that hinders future use of the form. This is because the pry bar's force is applied over a very limited surface area, whereas modular forms are engineered to withstand the forces of concrete applied broadly over an entire surface. Other workers use a sledge to drive a wedge or the straighter end of a pry bar between the modular form and the concrete to separate them. Both methods are used in the field and neither significantly reduces the strenuous labor of removing forms from underlying rigid concrete. Neither method eliminates the need to forcibly insert a pry bar tip between the modular form and the concrete to which it adheres, which is the most strenuous task in form stripping. Despite the release agent, many forms are bent, breached, or otherwise deformed during removal. This is a more significant concern with prefabricated modular forms since their increased cost is often recouped only through repeated use.

What is needed in the art is a method and tool to minimize or overcome some of the above deficiencies. Based on the foregoing, it is an object of the present invention to provide such a method and tool for removing modular forms from underlying concrete.

### SUMMARY OF THE INVENTION

The present invention contemplates a method, a combination or apparatus, and a tool. The method of the present invention for removing modular forms from rigid concrete comprises five distinct steps. First, provide a modular form removal tool, wherein the tool itself comprising a claw end defining a notch particularly adapted to engage a knob protruding from the modular form, a lever arm with an opposing end, and a fulcrum therebetween. Second, engage the claw end with the protruding knob. Third, place the fulcrum against an adjacent surface, such as the hardened concrete itself or an adjacent modular form. Fourth, apply a force to the lever arm in the direction of the concrete so that the form will tend to separate from the hardened concrete. And repeating the process as necessary to remove additional modular forms.

The combination apparatus of the present invention comprises at least two modular forms and a tool for removing a form from the concrete structure. More particularly, the modular form comprises an interior surface to abut fluid concrete that is poured into the adjacent space. The form has an opposing second or exterior surface spaced from the interior surface, and knobs that project from the exterior surface. The tool of the apparatus comprises a claw end terminating in a tip and defining a notch particularly adapted to engage the knob, and a lever arm defining an end opposite the tip. The tool further includes a fulcrum between the claw end and the lever arm. This fulcrum forms an abutment surface that is disposed opposite a line between the tip and the end.

The tool of the present invention for removing modular forms from hardened concrete comprises three main components: a claw end, a lever arm, and a fulcrum. The claw end terminates in a tip and has a notch particularly adapted to engage a knob protruding from the modular form. The lever arm defines an end opposite the tip. The fulcrum is located between the claw end and the lever arm, and defines an abutment surface that is disposed opposite a line between the tip and the end. The abutment surface is spaced from the line by at least twice the thickness of the modular form, and the fulcrum is attached to the remainder of the tool at a distance from the tip that is at least six times the thickness of the modular form. The thickness of the modular form is the distance between the form interior and exterior surfaces.

In another aspect of the present invention, an apparatus for removing modular forms comprises a lever arm including a first portion and a second portion serving as a handle. The second portion has a length greater than that of the first portion. The first and second portions are oriented at an angle with respect to each other. Means for engaging a stud of a form is coupled to an end of the first portion of the lever. A fulcrum is coupled to the first portion. Preferably, the first portion and the second portion cooperate with one another to define an acute angle between generally facing sides of the first and second portion such that the portions generally form a check “√” shape. The engaging means preferably includes a claw defining a notch for receiving a stud of the form.

In a further aspect of the present invention, an apparatus for removing modular forms comprises a lever arm having a first longitudinal end and a second longitudinal end. A projection extends beyond the first longitudinal end for engaging a slot defined in a modular form to be removed. A fulcrum is coupled to the lever arm, and is disposed closer to the first longitudinal end relative to the second longitudinal end. A knuckle guard is coupled to the lever arm, and is disposed closer to the second longitudinal end relative to the first longitudinal end. Preferably, the projection includes a hardened steel pin, and is angled relative to a longitudinal axis of the lever arm. Moreover, in an exemplary embodiment, each of the fulcrum and the knuckle guard is in the form of a hollow cylinder.

### BRIEF DESCRIPTION OF THE DRAWINGS

FIG. 1 is an elevational view of a device for removing modular forms in accordance with the present invention.

FIG. 2 is a plan view of the device of FIG. 1.

FIG. 3 is a perspective view of the device of FIG. 1 engaged with a modular form to remove it from an underlying structure.

FIG. 4 is a perspective view close up of a claw end of the device of FIG. 1 adjacent to a cutaway view of a modular form.

FIG. 5 is a side elevational view of a device for removing modular forms in accordance with a second embodiment of the present invention.

FIG. 6 is a front view of the device of FIG. 5.

FIG. 7 is a side elevational view of a device for removing modular forms in accordance with a third embodiment of the present invention.

FIG. 8 is a plan view of a device for removing modular forms in accordance with a fourth embodiment of the present invention.

FIG. 9 is a side elevational view of the device of FIG. 8.

### DETAILED DESCRIPTION OF THE PREFERRED EMBODIMENTS

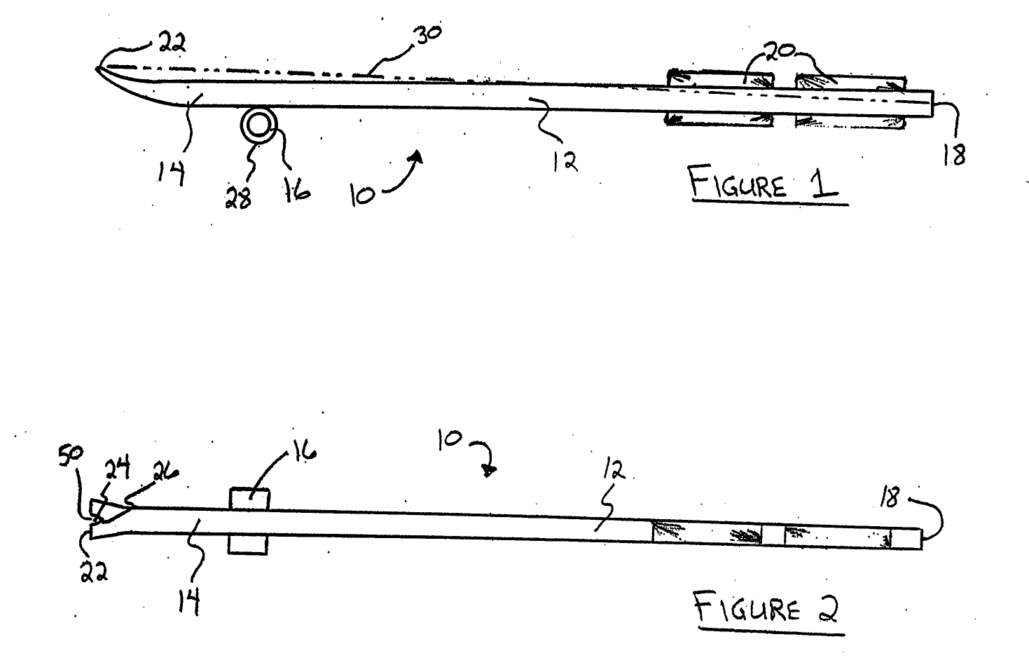

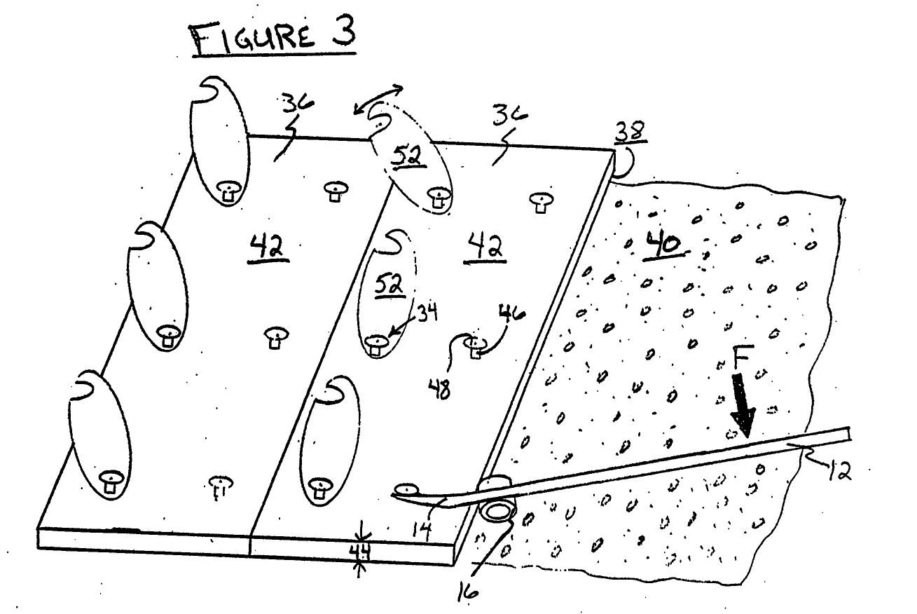

A fuller appreciation for the present invention may be achieved by reference to the associated illustrations, wherein FIGS. 1 and 2 depict in differing views a tool 10 for removing modular forms. The tool comprises a lever arm 12, a claw end 14, and a fulcrum 16 between them. The lever arm 12 is extended to provide a substantial moment arm about the fulcrum, preferably three to four feet in length. The lever arm defines an end 18 with a centroid (not shown), the centroid being the center point of the surface that defines the end 18. The lever arm 12 may include handgrips or pads 20 for the user's comfort.

The claw end 14 defines a tip 22. As shown in the elevational view (FIG. 1), the claw end incorporates a cross section that narrows nearer the tip 22. This narrowing cross section is for easy engagement with a knob of a modular form to be later described. The claw end further defines a notch 24, evident in the plan view of FIG. 2. The notch is particularly adapted to engage the knob previously mentioned. Preferably, the notch is defined by an arcuate surface 26, rather than by two converging linear surfaces as in prior art tools adapted for removal of nails and spikes. The notch of the present invention preferably does not score or deform the shank of the knob as prior art tools do to the shanks of nails or spikes.

The fulcrum 16 includes an abutment surface 28 for engaging a surface of hardened concrete, or any other sufficiently solid surface adjacent to the form to be removed. The abutment surface is opposite a line 30 defined by the tip 22 and the centroid of the lever arm end 18, and is shown in phantom in FIG. 1. The tip 22 of the claw end 18 is preferably bent away from the fulcrum 16 as in many pry bars. The fulcrum is preferably a hollow steel cylinder mounted so that its axis of rotation lies substantially perpendicular to the line 30 between the centroid and the tip, and is preferably welded to the remainder of the tool 10. It is preferably welded at a point within eighteen inches of the tip 18. Substantially perpendicular (or parallel) as used herein is limited to within 15° of the perpendicular (or parallel).

In a preferred embodiment of the tool of the present invention, the lever arm is three to four feet long and made of one-inch steel stock, the notch is slightly greater than one half inch wide, and the fulcrum is a two-inch diameter steel tube section welded eight inches from the tip. This is to accommodate many of the modular forms in use having a thickness of one inch and knobs having a one-half inch diameter shank set approximately six inches inboard from an edge of the modular form.

FIG. 3 depicts a perspective view of the tool 10 of FIG. 1 engaged with a protruding knob 34 of a modular form 36. The modular form has an interior surface 38 that abuts a concrete surface 40 of the underlying concrete structure, and an exterior surface 42 opposite the first and spaced therefrom by a thickness 44. Through the exterior surface protrude shanks 46 terminating in caps 48 that together comprise the knobs 34. As best shown in FIG. 2, the arcuate surface 26 is rounded into an ellipsoid to prevent marring or scoring of the shank 46, as opposed to general purpose pry bar claw ends that employ two converging surfaces each having acute angles that score and better grip a nail or spike. This arcuate surface 26 may or may not define an angle with the top of the tool (the top being shown in FIG. 2) or the opposing bottom, or it may blend via a rounded edge. The tip 22 also defines a notch opening 50 that is preferably slightly greater than one half of an inch wide, to easily accommodate a typical one half inch diameter shank. The entire surface of the tool's claw end that defines the notch may or may not be rounded. In a preferred embodiment, planar surfaces extend from the tip 22 and join with either side of the arcuate surface 26 to define the entire notch 24. Since the knob is engineered to withstand forces, transferred through bracing, that would tend to separate the cap 48 from the shank 46, the claw end 14 of the tool 10 imposes its primary force on the cap 48 when properly employed. This is opposed to prior art pry bars that grip the shank of a nail or spike with lateral contact on either side of the shank, and may extract a nail even if the nail-head is sheared off.

Bracing in the form of steel bands or clips 52 interconnects the knobs of adjacent modular forms to reinforce the forms and to prevent their separation from one another. Each steel band or clip 52 mates with a shank 46 of at least two knobs on adjacent modular forms to hold them together. These bands 52 may be hingedly attached to the shanks 46 of one of the modular forms to be joined as shown in FIG. 3 (movement indicated by the double-headed arrow), or they may remain a separate component until attached. Additional vertical and/or horizontal bracing is often required to prevent deflection of the joined-together forms, especially for taller and wider concrete structures. Once the forms are set and all bracing is in place, concrete is poured behind the assembled modular forms. The bracing is removed once the concrete is sufficiently cured.

The modular forms generally remain attached by adhesion to the underlying cured concrete and may be stripped or removed in the following manner. The claw end 14 of the tool 10 is engaged with a knob 34 such that the notch 24 engages the shank 46 underneath the cap 48. The abutment surface 28 of the fulcrum 16 is placed against the rigid concrete surface 40 adjacent to the form 36 to be stripped. Rigid concrete as used herein refers to concrete that has cured at least 24 hours. A force is applied to the lever arm 12 in the direction indicated by the heavy arrow F, which is toward the concrete surface. This force drives the claw end 14 against the cap 48, thus pulling the entire modular form away from the underlying concrete structure and breaking the adhesive bond therebetween. The tool is subsequently separated from the knob 34 and the concrete surface 40. In this manner, the tool 10 is used to strip one or more modular forms from underlying concrete without compromising the geometric or structural integrity of the form for future use.

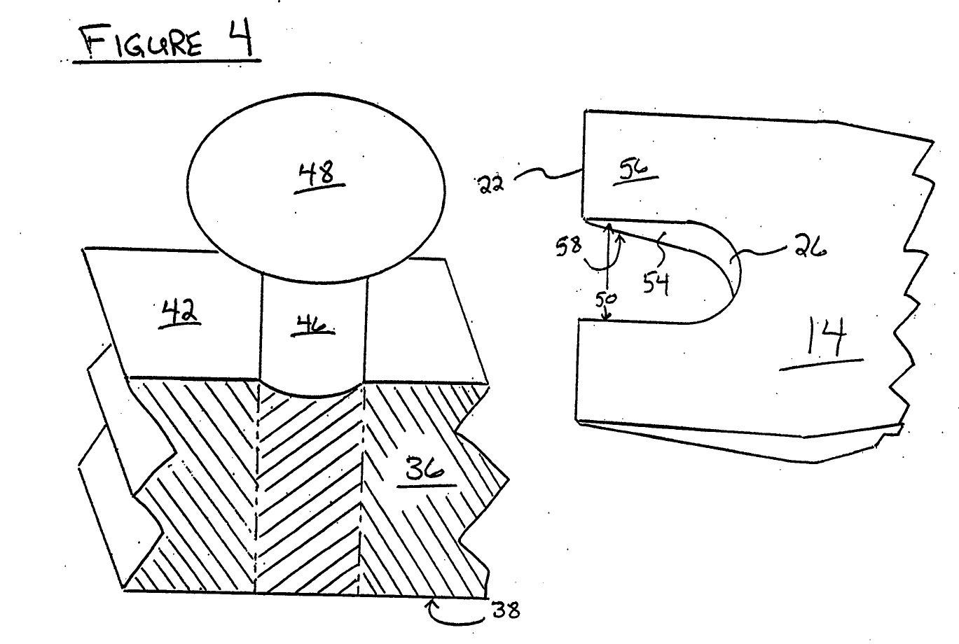

FIG. 4 shows in perspective view a close up of the claw end 14 of the tool proximal to a shank 46 and cap 48 of a modular form 36. The notch opening 50 is adapted to mate with the shank 46 of a knob protruding from a modular form 36. The claw end 14 defines a cross section that narrows as it approaches the tip 22, as shown. The notch is defined in part by an arcuate surface 26, and in part by opposing sidewalls 54 (lead line points to only one sidewall). The arcuate surface 26 defines a curve that is complementary to a portion of the surface of the shank 46. The opposed sidewalls 54 lie in planes that are preferably substantially parallel to the knob's shank 46. At least one of and preferably both sidewalls 54 are substantially perpendicular to both an adjacent upper surface 56 and an opposing adjacent lower surface 58 of the claw end 14. When engaged with a knob protruding from a modular form 36, the sidewalls 54 lie in planes that are substantially perpendicular to the exterior surface 42 of the form. The sidewalls 54 may also be substantially parallel to one another.

Prior art pry bars typically include incising edges (i.e. surfaces that define sharply acute angles at their junctures) and diverging sidewall surfaces defining the notch to better grip the shanks of a variety of nails or spikes. The tool of the present invention is directed to a single purpose. It need not grip the shank of the knob but rather presses against the cap 48 with its claw end upper surface 56, and it need not be adaptable to a variety of shank sizes.

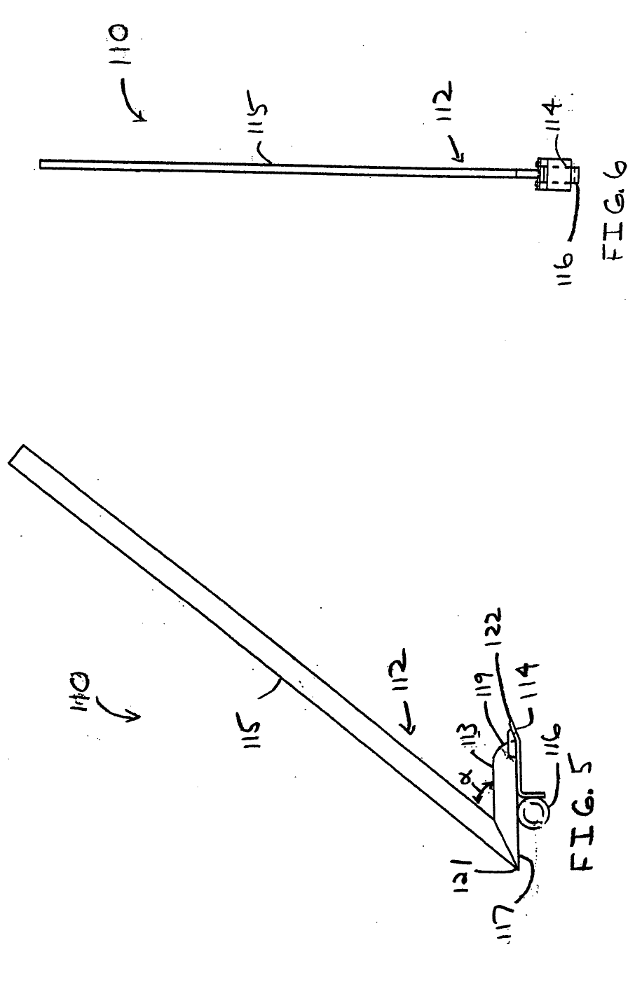

With reference to FIGS. 5 and 6, an apparatus for removing modular forms in accordance with a second embodiment of the present invention is indicated generally by the reference number 110. Like elements with the apparatus 10 of FIGS. 1-4 are indicated by like reference numbers preceded by “1”. The apparatus 110 is generally the same as the apparatus 10 except for the lever arm or handle. Accordingly, the apparatus 110 and its operation will be described in detail only with respect to the structure that is different from that of the apparatus 10.

The apparatus 110 comprises a lever arm 112, a head or claw 114 at an end of the lever arm, and a fulcrum 116 disposed therebetween. The apparatus 110 is employed for removing forms such as, for example, 1⅛″ plywood style modular forms, in a manner similar to that explained with respect to the apparatus 10 shown in FIGS. 1-4. The lever arm 112 includes a first portion 113 and a second portion 115 which are oriented at an angle α with respect to each other. The first portion 113 and the second portion 115 preferably cooperate to form an acute angle between generally facing sides of the first and second portions. The fulcrum 116, preferably in the form of a hollow steel cylinder, is coupled to the first portion 113 at a first side 117 thereof between a first longitudinal end 119 and a second longitudinal end 121. The claw 114 is also coupled to the first portion 113 at the first side 117 such that a tip 122 of the claw 114 extends slightly beyond the first end 119. Preferably, the tip 122 of the claw 114 is angled in a direction toward a second side 121 of the first portion 113 which is generally opposite to that of the first side 117.

The second portion 115 serves as a handle of the lever arm 112, and has a length which is greater than that of the first portion 113. As shown in FIG. 5, for example, the length of the second portion 115 is approximately five times the length of the first portion 113. However, the length of the second portion 115 can be greater or less than five times the length of the first portion 113 without departing from the scope of the present invention. The different lengths of the first and second portions 113, 115, and the acute angle formed therebetween are such that the first and second portions form a check “√” shape.

The lever arm 112 of the apparatus 110 is designed to aid in the removal of forms that are elevated above the footing. Removal of these forms using conventional methods and tools such as a hammer or pry bar can be dangerous because the operator of the tool is typically facing the wall while standing on narrow planks—often without a safety railing—mounted off of the back face of the forms. There is the danger of the operator falling off of the planking while performing the form removal process. Because the lever arm 112 is check-shaped, the apparatus 110 allows an operator to more safely remove elevated forms as explained below.

In operation, while standing on the planking, an operator stands with his or her back to the wall and engages a notch opening defined by the claw 114 of the apparatus 110 with a stud on the form that the form latch was previously latched on to. The operator then presses the fulcrum 116 against the form next to the form the operator is removing. Once contact is made, the operator exerts pressure on the handle 115 of the apparatus 110 so as to push the handle away from the operator's body as if the operator were performing a bench press. When the operator starts to exert pressure on the handle 115, the operator will be forcing his or her back against the wall. With the operator's back firmly pressed against the wall, the operator is in a much safer position during the form removal process.

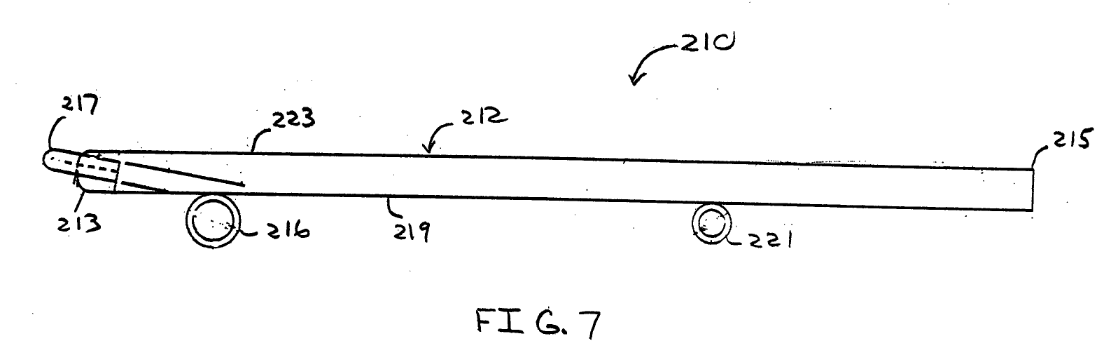

Referring to FIG. 7, an apparatus for removing modular forms in accordance with a third embodiment of the present invention is indicated generally by the reference number 210. Like elements with the apparatus of FIGS. 1-4 are indicated by like reference numbers preceded by “2”.

The apparatus 210 comprises a lever arm or handle 212 having a first longitudinal end 213 and a second longitudinal end 215. A projection 217 such as, for example, a hardened steel pin, extends slightly beyond the first longitudinal end 213 of the lever arm 212. A fulcrum 216, preferably in the form of a hollow cylinder, is coupled to the lever arm 212 at a first side 219 thereof, and is disposed therealong closer to the first longitudinal end 213 relative to the second longitudinal end 215. The apparatus 210 preferably includes a knuckle guard 221 coupled to the lever arm 212 at the first side 219 thereof, and is disposed therealong closer to the second longitudinal end 215 relative to the first longitudinal end 213. The knuckle guard 219 is in the form of a hollow cylinder but can take other practical shapes without departing from the scope of the present invention. As shown in FIG. 7, the projection 217 is angled in a direction toward a second side 223 of the lever arm 212 which is generally opposite to that of the first side 219.

The apparatus 210 is designed to aid in the removal of what is known in the industry as SYMONS steel frame forms manufactured by Symons Corporation of Des Plaines, Ill., or equivalent compatible steel frame forms that define slots along the sides of the forms.

The apparatus 210 is employed on a form in which adjacent forms on each side thereof have already been removed from the face of the wall to thereby expose slots defined along sides of the form. In operation, the projection 217 is inserted into a slot defined in a side of a steel frame of the form at an upper portion of the form. Once the projection 217 is engaged in a slot, the operator pushes the handle 212 toward the face of the wall. This causes the apparatus 210 to pivot on the fulcrum 216 so as to permit the projection 217 of the apparatus 210 to pull the form away from the face of the wall. The apparatus 210 is then removed from the slot and is moved to another slot defined in the side of the frame of the form at a middle portion of the form. The procedure is then repeated. Once complete, the apparatus 210 is moved to a further slot defined in the side of the frame of the form at a lower portion of the form, and the procedure is again repeated.

At this point, the form has been partially pulled away from the face of the wall, but is likely “hung up” on the form ties. In order to completely remove the form, the apparatus 210 is then flipped end for end, and then turned so that the fulcrum 216 and the knuckle guard 221 are on the side of the handle 212 that is facing the operator. The operator then inserts the second end 215 of the handle 212 between the form and the face of the wall until the knuckle guard 221 comes into contact with the side of the form. The handle 212 is making contact with the form and the wall on its bottom and top respectively—not on the sides of the handle. A prying motion is then applied by the operator to the apparatus 210, by pulling on the handle 212, which pulls the form past the ties and frees it from the wall.

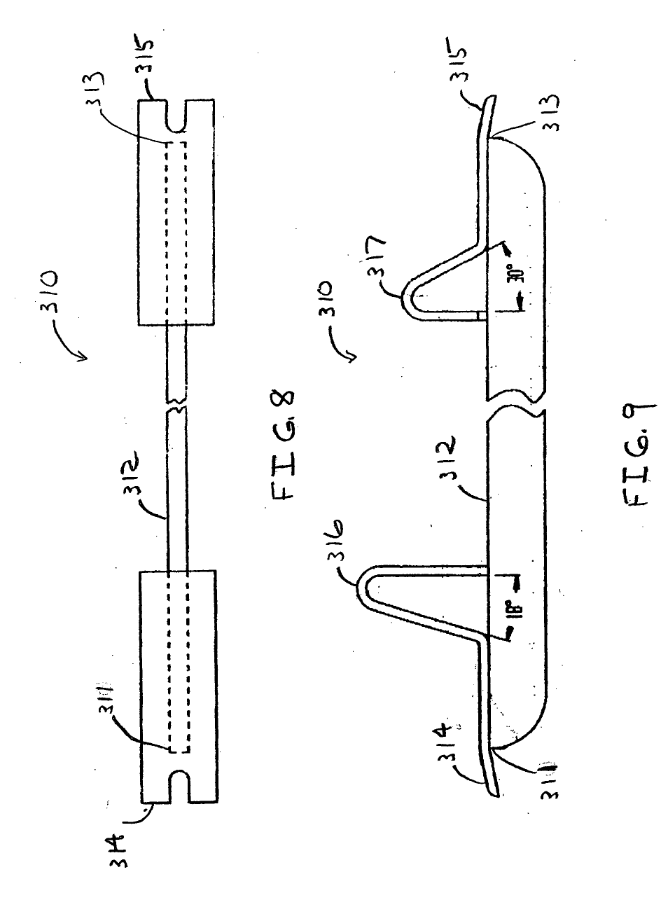

Referring to FIGS. 8 and 9, an apparatus for removing modular forms in accordance with a fourth embodiment of the present invention is indicated generally by the reference number 310. Like elements with the apparatus of FIGS. 1-4 are indicated by like reference numbers preceded by “3”.

The apparatus 310 is generally similar to the apparatus 10 of FIGS. 1-4 except that the apparatus 310 includes pulling heads on both ends of the handle. As shown in FIGS. 8 and 9, the apparatus 310 comprises a lever arm 312 having a first longitudinal end 311 and a second longitudinal end 313. The apparatus 310 further comprises a first head or claw 314 at the first longitudinal end 311 of the lever arm 312, a first fulcrum 316 associated with the first head and disposed along the lever arm 312 closer to the first longitudinal end 311 relative to the second longitudinal end 313. A second head or claw 315 is disposed at the second longitudinal end 313 of the lever arm 312, and a second fulcrum 317 associated with the second head is disposed along the lever arm 312 closer to the second longitudinal end 313 relative to the first longitudinal end 311.

The first and second fulcrums 316, 317 are respectively preferably of unitary construction with the first and second heads 314, 315. The first fulcrum 316 extends outwardly from the lever arm 312 to form an arcuate surface to enable the lever arm 312 to pivot thereon when the first head 314 engages a stud of a form to be removed. Similarly, the second fulcrum 317 extends outwardly from the lever arm 312 to form an arcuate surface to enable the lever arm 312 to pivot thereon when the second head 315 engages a stud of a form to be removed. As shown in FIG. 9, the first fulcrum 316 extends outwardly from the lever arm 312 a greater distance relative to that of the second fulcrum 317, but can be modified to extend outwardly the same distance or various other greater or lesser distances relative to that of the second fulcrum without departing from the scope of the present invention.

The apparatus 310 operates in a similar manner to that described with respect to the apparatus 10 of FIGS. 1-4. However, one or both of the first and second heads 314, 315 can be used to engage a stud of a form to be removed depending on the degree of leverage needed to pull the form from a wall.

While the preferred embodiments and methods have been shown and described, various changes and substitutions will be apparent to those skilled in the art and may be made without departing from the spirit and scope of the present invention. The embodiments and methods described above are hereby stipulated as illustrative rather than exhaustive.

What is claimed is:

1. A method for removing modular forms from hardened concrete comprising the steps of:
providing a modular form removal tool, said tool having a claw end defining a notch particularly adapted to engage a knob protruding from an exterior surface of the modular form, a lever arm with an opposing end, and a fulcrum therebetween;
engaging the claw end with the knob;
abutting the fulcrum against a rigid concrete surface adjacent to the modular form;
applying a force to the lever arm in the direction of the concrete surface that tends to separate the modular form from the hardened concrete; and
repeating the above process steps as necessary to remove additional modular forms from the hardened concrete.

2. The method of claim 1 wherein the claw end defines a rounded interior surface of the notch that mates with a shank of the knob.

3. The method of claim 2 wherein the claw end terminates in a tip, said tip defining a notch opening at least one half inch wide.

4. The method of claim 2 wherein the claw end further defines sidewalls that are substantially perpendicular to the exterior surface of the modular form when the claw end is engaged with the knob.

5. An apparatus for forming a hardened concrete structure from fluid concrete comprising at least two modular forms and a tool for removing the forms,
wherein each modular form comprises:
an interior surface to abut fluid concrete that cures into the hardened concrete structure,
an opposing exterior surface separated from the interior surface, and
at least one knob projecting from the exterior surface;
and the tool comprises:
a claw end having a notch particularly adapted to engage the knob,
a lever arm defining, and
a fulcrum between the claw end and the lever arm forming an abutment surface.

6. The apparatus of claim 5 wherein the notch is further defined by sidewalls and an arcuate surface, the sidewalls being substantially perpendicular to the exterior surface of the modular form when the claw end is engaged with the knob.

7. The apparatus of claim 6 wherein the sidewalls are substantially perpendicular to both an adjacent upper surface of the claw end and to an opposing adjacent lower surface of the claw end.

8. A tool for removing modular forms from hardened concrete comprising:
a claw end terminating in a tip and defining a notch particularly adapted to engage a knob protruding from the modular form,
a lever arm defining an end opposite said tip, and
a fulcrum between the claw end and the lever arm with an abutment surface disposed opposite a line between the tip and the end,
wherein the abutment surface is spaced from the line by at least twice the thickness of the modular form, and
wherein the fulcrum is spaced from the tip by at least six times the thickness of the modular form.

9. The tool as defined by claim 8 wherein the fulcrum is attached at least seven inches from the tip.

10. The tool as defined by claim 8 wherein the fulcrum is a cylinder.

11. The tool as defined by claim 10 wherein the cylinder defines an axis of rotation that is substantially perpendicular to the line.

12. The tool as defined by claim 8 wherein the fulcrum is spaced from the tip at least 14% of the total distance of the line.

13. The tool as defined by claim 8 wherein the claw end defines a notch having a rounded interior surface particularly adapted to engage the knob's cap without scoring the knob's shank.

14. The tool as defined by claim 13 wherein the tip defines a notch opening measuring at least one half inch across.

15. In an apparatus for forming a hardened concrete structure wherein a plurality of modular forms are joined together to contain fluid concrete until it hardens, each form having at least one knob with a shank, the improvement comprising a tool for separating the modular forms from the hardened concrete structure that includes a lever arm, a fulcrum and a claw end defining opposing sidewalls and an arcuate surface forming a notch, the sidewalls being aligned substantially parallel to the shank when the claw end engages the shank.

16. The apparatus of claim 15 wherein the arcuate surface is complementary to a portion of the shaft's surface.

17. The apparatus of claim 16 wherein the sidewalls are substantially parallel to each other.

18. The apparatus of claim 15 wherein the sidewalls are substantially perpendicular to both an adjacent upper surface of the claw end and an adjacent lower surface of the claw end.

19. An apparatus for removing modular forms, comprising:
a lever arm including:
a first portion; and
a second portion serving as a handle, the second portion having a length greater than that of the first portion, the first and second portions being oriented at an angle with respect to each other;
means coupled to an end of the first portion of the lever arm for engaging a stud of a form; and
a fulcrum coupled to the first portion.

20. The apparatus of claim 19, wherein the first portion and the second portion cooperate with one another to define an acute angle between generally facing sides of the first and second portion.

21. The apparatus of claim 20, wherein the first portion and the second portion cooperate with one another to generally form a check “√” shape.

22. The apparatus of claim 19, wherein the engaging means includes a claw defining a notch for receiving a stud.

23. The apparatus of claim 19, wherein the fulcrum includes a hollow cylinder.

24. The apparatus of claim 19, wherein the length of the second portion is approximately five times the length of the first portion.

25. An apparatus for removing modular forms, comprising:
a lever arm having a first longitudinal end and a second longitudinal end;
a projection extending beyond the first longitudinal end for engaging a slot defined in a form;
a fulcrum coupled to the lever arm, the fulcrum being disposed closer to the first longitudinal end relative to the second longitudinal end; and
a knuckle guard coupled to the lever arm, the knuckle guard being disposed closer to the second longitudinal end relative to the first longitudinal end.

26. The apparatus of claim 25, wherein the projection includes a hardened pin.

27. The apparatus of claim 25, wherein the projection includes a hardened steel pin.

28. The apparatus of claim 25, wherein the projection is angled relative to a longitudinal axis of the lever arm.

29. The apparatus of claim 25, wherein the fulcrum includes a hollow cylinder.

30. The apparatus of claim 25, wherein the knuckle guard includes a hollow cylinder.

31. An apparatus for removing modular forms, comprising:
a lever arm having a first longitudinal end and a second longitudinal end;
first means coupled to the first longitudinal end of the lever arm for engaging a stud of a form;
a first fulcrum coupled to the lever arm, the first fulcrum being disposed closer to the first longitudinal end relative to the second longitudinal end;
second means coupled to the second longitudinal end of the lever arm for engaging a stud of a form; and
a second fulcrum coupled to the lever arm, the second fulcrum being disposed closer to the second longitudinal end relative to the first longitudinal end.

32. An apparatus of claim 31, wherein the first and second engaging means each include a claw defining a notch for receiving a stud.

33. An apparatus of claim 31, wherein the first and second fulcrums are respectively of unitary construction with the first and second engaging means.

34. An apparatus of claim 31, wherein the first fulcrum extends outwardly from the lever arm a greater distance relative to that of the second fulcrum.
